(19) United States
(12) Patent Application Publication
(10) Pub. No.: US 2025/0262593 A1
(43) Pub. Date: Aug. 21, 2025

(54) APPARATUS AND PROCESS FOR PROVIDING A PRODUCTION GAS OUTPUT FROM AN AIR SEPARATION SYSTEM

(71) Applicant: Air Products and Chemicals, Inc., Allentown, PA (US)

(72) Inventors: Jhoan Esteban Useche Morales, Emmaus, PA (US); Thomas M. Yeh, Lansdale, PA (US)

(73) Assignee: Air Products and Chemicals, Inc., Allentown, PA (US)

(21) Appl. No.: 18/443,931

(22) Filed: Feb. 16, 2024

(51) Int. Cl. B01D 53/26; B01D 53/04; B01D 53/28; B01J 20/18; B01J 20/34

(52) U.S. Cl. CPC B01D 53/261; B01D 53/0438; B01D 53/0446; B01D 53/28; B01J 20/18; B01J 20/3408; B01J 20/3483; B01D 2253/108; B01D 2256/10; B01D 2256/12; B01D 2256/18; B01D 2257/80; B01D 2259/40088; B01D 2259/455

(57) ABSTRACT

An apparatus and process for drying a product gas for feeding the gas to a downstream user so that product gas can be dried to remove water from the gas that may be absorbed or adsorbed during an initial start-up phase of the product gas production and/or delivery (e.g. from conduits that may have been exposed to water during installation) so the product gas can be passed downstream to the user instead of being vented. Some embodiments can be configured to utilize a removable, mobile water redistribution device that can be transported to a new site after an initial start-up phase of product gas delivery is completed and the product gas providing conduit arrangement has been dried via operation for an initial start-up period of time.

### FIELD OF THE INVENTION

The present innovation relates to processes and apparatuses for conveying a product gas produced via air separation of a feed (e.g. a nitrogen product stream, oxygen product stream, or argon product stream output from an air separation unit processing air or an industrial gas stream, etc.).

### BACKGROUND OF THE INVENTION

Air separation processing has been utilized to separate air into different constituent flows of fluid (e.g. nitrogen, oxygen, etc.). Examples of systems that were developed in conjunction with air separation processing include U.S. Pat. No. 4,022,030, U.S. Pat. No. 4,822,395, International Patent Publication Nos. WO2020/169257, WO2020/244801, WO 2021/078405 and U.S. Pat. App. Pub. Nos. 2019/0331417, 2019/0331418, and 2019/0331419.

### SUMMARY OF THE INVENTION

We determined that air separation processing can result in delayed supplying of nitrogen, oxygen, argon, or other air separation product gas to one or more downstream customers during a start-up phase of the process. The start-up phase of the process can occur after installation, after maintenance work is performed, or after a turnaround event has occurred. For example, equipment utilized to transport produced product gas (e.g. nitrogen, oxygen, or argon) output from an air separation system to a downstream user (e.g. a customer who may utilize nitrogen gas output from the air separation process, a customer who may utilize oxygen output from the air separation process, etc.) can have moisture therein that is absorbed by the product gas passing through the conduit equipment. This absorption of water via the product gas after it is output from an air separation unit can result in the purity of the product gas failing to meet end user concentration requirements for use of that product gas such that the initially formed product gas must be vented until the downstream conduits used to convey the gas from the air separation unit to the customer plant are sufficiently dried to avoid such impurity absorption issues. We determined that this can occur even though the product gas output from the air separation unit meets the purity requirements for that gas due to water from newly installed conduit equipment (e.g. piping, etc.) having been exposed to moisture during installation (e.g. from rain, dew, frost, etc.) and that moisture being adsorbed by the product gas as the gas is conveyed from the air separation unit to a customer facility through this conduit equipment.

We determined that this type of impurity absorption issue can delay the providing of the product gas to an end user for many weeks-particularly in situations where the conduit equipment may have been exposed to rain during installation and the end user has a high product gas purity requirement (e.g. over 99.99 volume percent (vol %) nitrogen, between 99.9 vol % nitrogen and 100 vol % nitrogen, a nitrogen purity in which no more than 10 parts per billion (ppb) of water is within the nitrogen being provided, a nitrogen purity in which there is between 5 ppb and 2 ppb water, a nitrogen purity in which there is between 3 ppb impurities and 2 ppb impurities, a nitrogen purity in which there is between 100 ppb and 2 ppb water, etc.).

We determined that a product gas water redistribution device can be included in the output conduit pathway for providing the product gas to the downstream end user so that the product gas can be dried to remove the water that is adsorbed from newly installed conduit surfaces or recently exposed conduit surfaces (e.g. that may occur as a result of maintenance work, etc.) as the gas is passed to a customer site. The use of the water redistribution device can facilitate drying of the product gas for avoiding or minimizing the need to vent the product gas produced by an air separation process during its initial start-up phase. In some embodiments, the water redistribution device can also facilitate a subsequent humidification of a dried gas that is fed to the water redistribution device for slightly humidifying the gas while keeping that gas within a customer purity specification and also allowing adsorbent material of the device to be regenerated.

For instance, some embodiments of the water redistribution device can be configured to function as a water adsorber device or a water adsorber and desorber device that can be configured to redistribute the water absorption within the initially produced product gas so that the water that may be adsorbed by the product gas passing through a transport conduit arrangement during feeding of the product gas to the end user can be captured when the product gas has adsorbed too much water during transit to a customer site. This type of feature can permit the product gas to be delivered within customer purity requirements when it would have otherwise been outside a customer purity requirement. Embodiments can be configured to redistribute how the water is included within the product gas passed to the end user during the start-up phase of the production of the gas or the delivery of the gas to a customer site so that the product gas delivered to a customer site is sufficiently pure to meet the end user's product gas concentration requirements, or purity specifications. This can help avoid or minimize the need to vent a product gas produced during the initial start-up of the air separation process.

We determined that other embodiments can be configured for use in conjunction with drying of a nitrogen product stream, an oxygen product stream or an argon product stream that may be output from an air separation process for feeding to a downstream end user during a start-up phase of operation or the start-up phase of delivery of the product gas that can occur after the conduit arrangement for providing the product gas to the downstream user has been installed. Embodiments can be configured so that a water redistribution device can be utilized in conjunction with other types of air separation product stream conduit arrangements for redistribution of water adsorption that can occur from the conduits and other equipment installed for conveying the product gas stream to the end user to minimize or avoid venting of the initially formed product stream during the start-up phase of the air separation process and/or start-up phase of feeding of the product gas stream to the downstream user.

Some embodiments of the water redistribution device can be configured to be modular and removable. For instance, a water redistribution device can be configured and arranged for being mounted on a skid, trailer, or other type of mobile base for being connected to a nitrogen output conduit, oxygen output conduit, or argon output conduit during the start-up phase of an air separation process. After the installed output conduit arrangement has been sufficiently dried via the passing of the product gas through the output conduit and water redistribution device, the water redistribution device can be removed from the output conduit arrangement and transported to a new installation for use during that new installation's start-up phase. Such a modular and mobile approach can permit the capital cost associated with the water redistribution device to be recovered over multiple uses at multiple different installations. This type of approach can also avoid having to utilize the water redistribution device only for a start-up phase and then leave the water redistribution device on a site without it being used so that the cost incorporated not the fabrication and use of the water redistribution device can be more effectively recovered. This type of approach can also provide greater operational flexibility for air separation processing installation and startup designs.

Other embodiments can be configured so that the utilized water redistribution device can be deactivated, but remain on-site (e.g. valves can be adjusted to adjust the flow of product gas so the flow of product gas no longer passes through the water redistribution device while that device stays connected to the conduit arrangement). Such an approach can be utilized in embodiments where there is a desire to keep the water re-distribution functionality available for other use at the site, for example. Such an approach can provide greater flexibility in addressing situations where an air separation process may undergo product purity issues during operations that may occur after the initial start-up phase so that the water redistribution device can be employed via valve adjustments so the water redistribution device can again be utilized to dry the product gas flow to mitigate such issues that may arise during air separation operations.

In some embodiments, the water redistribution device can include a vessel having a bed of adsorbent material. The device can also include a heater that can be activated to heat the vessel and bed of adsorbent material therein to facilitate regeneration of the adsorbent material. For example, during an initial phase, the product gas can be passed through the adsorbent material within the vessel to adsorb water within the product gas to retain the product gas purity for providing to a customer. After the conduit arrangement is dried from the product gas being passed through it over a period of time (e.g. weeks, months, etc.), the product gas fed to the device can be sufficiently dry and can be able to desorb water from the adsorbent material and still be within the customer purity specification. In response to detection of such a situation, the heater device can be activated to heat the vessel of the device so that the product gas passed through the adsorbent material functions as a regeneration gas and some water desorbs from the adsorbent material and into the product gas while still keeping the product gas within a customer's product specification. This regeneration phase of the providing of the product gas can occur until the adsorbent material of the device is fully regenerated or sufficiently regenerated. After regeneration of the adsorbent material has occurred, the passing of the product gas to a customer site can be adjusted so that the product gas bypasses the water redistribution device to avoid the pressure drop of having that gas passed through the water redistribution device as the conduit arrangement through which the product gas passes can be sufficiently dried from prior use.

In yet other embodiments, no heater may be utilized to facilitate regeneration of the adsorbent material. In some alternative embodiments, the drier product gas can be passed through the water redistribution device for desorbing water from the bed of adsorbent material at acceptable levels for a desorption time period for regeneration of the bed of adsorbent material in a way that can facilitate the redistribution of the water adsorbed from various conduit elements so that the product gas conveyed to a customer site can still meet customer purity specifications. The water redistribution device may then be bypassed after the adsorbent bed is sufficiently regenerated in some such embodiments so that the water redistribution device can be available for another use at a later point in time.

In some embodiments, the water redistribution device can be decoupled from the conduit arrangement after it is being bypassed by the product gas for use at another site. In other embodiments, the water redistribution device can remain on-site for subsequent use in the event of a production issue, turn down, maintenance, or other issue that may arise during operation.

In a first aspect, an apparatus for production and/or delivery of a product gas of an air separation unit (ASU) can include a water redistribution device (WRD) configured to receive a product gas output from the ASU to remove water from the product gas to adjust a purity of the product gas so the product gas has a purity within a pre-selected purification content specification. The WRD can be positionable between the ASU and a customer system to receive the product gas from the ASU and output the product gas at the purity within the pre-selected purification content specification to feed the product gas to the customer system.

Embodiments of the apparatus can include just the WRD, or can include the WRD as well as other elements. For example, some embodiments of the apparatus can include the ASU and/or the customer system. Conduits for passing the product gas from the ASU to the WRD and from the WRD to the customer system can also be included. Other elements may also be provided (e.g. valves, a bypass conduit, etc.).

For example, in a second aspect the apparatus can include a conduit arrangement having a WRD feed conduit through which the product gas is passable to feed to the WRD and a WRD bypass conduit through which the product gas is passable to bypass the WRD and avoid being passed through the WRD when the product gas is fed to the customer system via the conduit arrangement.

In some embodiments, the conduit arrangement can include a split location upstream of the WRD and the WRD bypass conduit. The conduit arrangement can also include a WRD feed valve of the WRD feed conduit that can be adjustable between an open position for passing of the product gas to the WRD and a closed position for passing the product gas to the WRD bypass conduit.

In other embodiments, the conduit arrangement can include a split location upstream of the WRD and the WRD bypass conduit and a WRD bypass valve of the WRD bypass conduit can be adjustable between a closed position for passing of the product gas to the WRD and an open position for passing the product gas through the WRD bypass conduit.

In yet other embodiments, the conduit arrangement can include a WRD feed valve of the WRD feed conduit that is adjustable between an open position for passing of the product gas to the WRD and a closed position for passing the product gas to the WRD bypass conduit. The WRD feed valve can be downstream of a split location that is also upstream of the WRD and the WRD bypass conduit. In such an embodiment, the WRD bypass conduit can also include a WRD bypass valve that can be adjustable between a closed position for passing of the product gas to the WRD and an open position for passing the product gas through the WRD bypass conduit.

In a third aspect, the WRD can include a vessel retaining a bed of adsorbent material. The adsorbent material can include molecular sieve adsorbent material or other suitable adsorbent material. In some embodiments, the WRD can include at least one adsorber having a bed of adsorbent material within a vessel of the WRD, for example.

In a fourth aspect, the WRD can include a vessel retaining a bed of adsorbent material and the WRD can also be configured to receive the product gas through the WRD after the conduit arrangement has been dried so that water adsorbed by the bed of adsorbent material desorbs into the product gas during a desorption phase of operation of the WRD such that desorbed water within the product gas still results in the product gas output from the WRD having the purity within the pre-selected purification content specification. For example, the WRD can operate in a first adsorption phase in which water within a conduit through which the product gas output from the ASU may pass is adsorbed or absorbed by the product gas can be removed from the product gas via adsorption within the WRD. Then, in a second desorption phase that can occur after the adsorption phase, the WRD can desorb water that was previously adsorbed by dryer product gas that has passed through the dried conduit arrangement to help regenerate the adsorbent material of the WRD.

In some embodiments, the apparatus can also include a regeneration heater connected to the vessel to heat the vessel for regeneration of the adsorbent material as the product gas is passed through the WRD during the desorption phase of operation. In other embodiments, no regeneration heater may be used or needed to help facilitate desorption of water from the adsorbent material and into the dryer product gas passed through the WRD during the desorption phase of operation.

In a fifth aspect, the WRD can be supported by a mobile base. The mobile base can be connectable to a vehicle for transportation of the WRD. For example, the mobile base can be positioned on or integrated into a trailer, a truck, a flatbed, a mobile skid, or a railcar. In some embodiments, the mobile base can be a skid or mobile bed that can be towed or otherwise transported via a truck, barge, train, or other vehicle, for example,

In a sixth aspect, the WRD can have an inlet connected to the vessel and an outlet connected to the vessel. The inlet can be removably connectable to the conduit arrangement and the outlet can be removably connectable to the conduit arrangement. The inlet and outlet can be coupled to a conduit arrangement for facilitating use of the WRD. The inlet and outlet can be decoupled from the conduit arrangement to facilitate movement of het WRD to a new site for use at a new location.

In a seventh aspect, the product gas can be nitrogen or include nitrogen and the pre-selected purification content specification can be that the product gas has a water content of no more than 100 parts per billion (ppb) water and/or a nitrogen content of at least 99.9 volume percent nitrogen. For example, the pre-selected purification content specification can be that the product gas has between 100 ppb water and 2 ppb water, between 10 ppb water and 2 ppb water, or between 5 ppb water and 2 ppb water.

In an eighth aspect, the apparatus of the first aspect can include one or more features of the second aspect, third aspect, fourth aspect, fifth aspect, sixth aspect and/or seventh aspect. It should therefore be appreciated that embodiments of the apparatus can also include other features or other elements.

In a ninth aspect, a process for production and/or delivery of a product gas of an air separation unit (ASU) is provided. Some embodiments of the process can include passing product gas output from the ASU to a water redistribution device (WRD) to adjust a purity of the product gas so the product gas has a purity within a pre-selected purification content specification. The WRD can be connectable to a conduit arrangement positioned between the ASU and a customer system to receive the product gas from the ASU and output the product gas at the purity within the pre-selected purification content specification to feed the product gas to the customer system. After water has been sufficiently removed from the conduit arrangement via the passing of the product gas to the WRD, the passing of the product gas can be adjusted so that the product gas bypasses the WRD as the product gas is passed from the ASU to the customer system.

It should be appreciated that embodiments of the apparatus can be configured to implement an embodiment of the process. The process can also include other steps or other features.

For example, in a tenth aspect, the process can include decoupling the WRD from the conduit arrangement and moving the WRD to another site for connection with a conduit arrangement of that site after the adjusting of the passing of the product gas so that the product gas bypasses the WRD is performed.

As another example, the process can include activating a regeneration heater connected to a vessel of the WRD for heating the vessel for regeneration of adsorbent material of the WRD after determining that water has been sufficiently removed from the conduit arrangement via the passing of the product gas to the WRD and that desorption of the water into the product gas passed through the WRD will result in the product gas output from the WRD having the purity within the pre-selected purification content specification.

As yet another example, the process can include starting up the ASU for producing the product gas to feed to the customer system. The starting up of the ASU can occur after repair work was done on the conduit arrangement or after the conduit arrangement was installed and may have been exposed to ambient moisture (e.g. humidity and/or rain), for example.

In an eleventh aspect, the WRD can have a pre-selected design and structure. For example, the WRD can include a vessel having a bed of adsorbent material therein.

In a twelfth aspect, the passing of the product gas output from the ASU to the WRD to adjust a purity of the product gas so the product gas has the purity within the pre-selected purification content specification can also be performed to include passing the product gas through the WRD after the product gas has passed through the conduit arrangement such that the bed of adsorbent material adsorbs water from the product gas during a first adsorption phase of operation of the WRD and passing the product gas through the WRD after the conduit arrangement has been dried so that water adsorbed by the bed of adsorbent material desorbs into the product gas during a second desorption phase of operation of the WRD such that the desorbed water within the product gas still results in the product gas output from the WRD having the purity within the pre-selected purification content specification.

In a thirteenth aspect, the product gas can include nitrogen and the pre-selected purification content specification used in the process can be or include a water content of no more than 100 ppb water and/or a nitrogen content of at least 99.9 volume percent nitrogen.

In a fourteenth aspect, the product gas is nitrogen, oxygen, or argon. In yet other embodiments, it is contemplated that the product gas can be another type of gas.

In a fifteenth aspect, the process can include determining that the water has been sufficiently removed from the conduit arrangement via the passing of the product gas to the WRD such that the product gas is passable to the customer system without treatment via the WRD based on sensor data from sensors of the conduit arrangement, a surface area of the conduit arrangement, and/or a duration of time in which the product gas has been passed through the WRD. Adjusting the conduit arrangement so that the WRD is bypassed and/or adjusting the WRD operation so that it can function in a desorption phase can be triggered to occur as a result of such a determination in some embodiments.

In a sixteenth aspect, the process of the ninth aspect can include one or more features of the tenth aspect, eleventh aspect, twelfth aspect, thirteenth aspect, fourteenth aspect and/or fifteenth aspect. It should therefore be appreciated that other embodiments of the process can include other features, process steps, or combinations of different features and process steps.

It should be appreciated that embodiments of the process and apparatus can utilize various conduit arrangements and process control elements. The embodiments may utilize sensors (e.g., pressure sensors, temperature sensors, flow rate sensors, concentration sensors, etc.), controllers, valves, piping, and other process control elements. Some embodiments can utilize an automated process control system and/or a distributed control system (DCS), for example. Various different conduit arrangements and process control systems can be utilized to meet a particular set of design criteria.

Other details, objects, and advantages of our apparatus for product gas production and/or delivery, process for product gas production and/or delivery, process for production and/or delivery of a product gas of an air separation unit (ASU), apparatus for production and/or delivery of a product gas of an ASU, water redistribution device, and methods of making and using the same will become apparent as the following description of certain exemplary embodiments thereof proceeds.

### BRIEF DESCRIPTION OF THE DRAWINGS

Exemplary embodiments of our apparatus for product gas production and/or delivery, process for air separation product gas production and/or delivery, process for production and/or delivery of a product gas of an ASU, apparatus for production and/or delivery of a product gas of an ASU, water redistribution device, and methods of making and using the same are shown in the drawings included herewith. It should be understood that like reference characters used in the drawings may identify like components.

FIG. 1 is a block diagram of a first exemplary embodiment of an apparatus for product gas production and/or delivery. An exemplary embodiment of a process for air separation product gas production and/or delivery can also be appreciated from FIG. 1.

FIG. 2 is a block diagram of a first exemplary implementation of the first exemplary water redistribution device that can be utilized in the first exemplary embodiment of the apparatus for product gas production.

FIG. 3 is a flow chart illustrating an exemplary embodiment of a process for air separation product gas production and/or delivery. The first exemplary embodiment of the apparatus for product gas production and/or delivery can implement this first exemplary embodiment of the process.

### DETAILED DESCRIPTION OF THE INVENTION

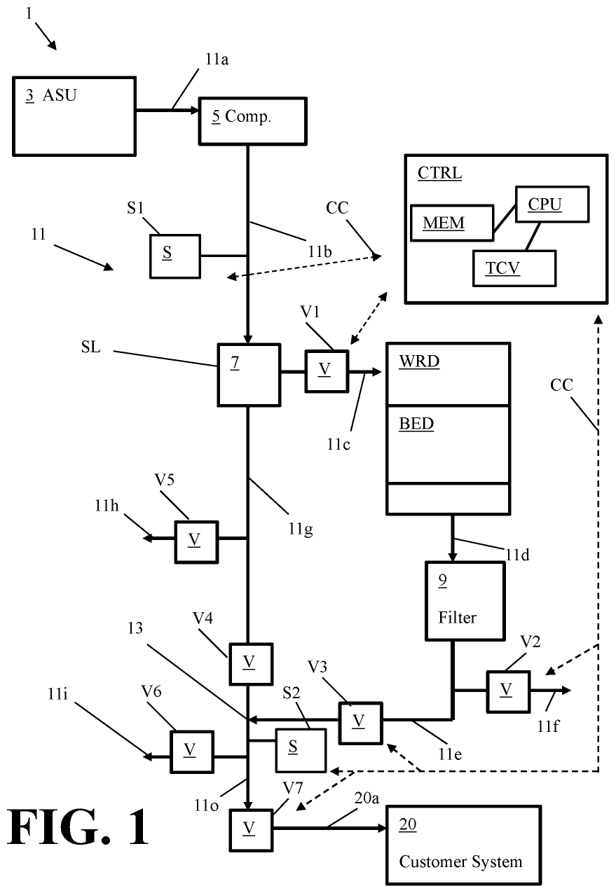

Referring to FIGS. 1-3, an apparatus 1 for product gas production and/or delivery can be configured to utilize a water redistribution device to facilitate feeding of the product gas to a downstream user so that product gas formed during an initial start-up of the production process and/or delivery process can be provided to the downstream user without having to be vented or to minimize venting of initially provided product gas. The product gas that can be conveyed via at least one output conduit for feeding the product gas to the downstream end user can be a high purity nitrogen product, a high purity oxygen product, or a high purity argon product, for example. Such a high purity product gas can be, for example, between 99 vol % and 100 vol % oxygen, between 99 vol % and 100 vol % nitrogen, or between 99 vol % and 100 vol % argon. In some embodiments, the product gas that is provided during the initial start-up phase to the downstream user can have less than or equal to 100 parts per billion (ppb) water within the product gas or the product gas that is provided during the initial start-up phase to the downstream user can have between 5 ppb water and 2 ppb water, between 10 ppb water and 2 ppb water, between 20 ppb water and 2 ppb water, between 100 ppb water and 2 ppb water, or other pre-selected water concentration specification.

The apparatus 1 can be configured as an apparatus for production and/or delivery of a product gas. The product gas can be output from an air separation unit (ASU). The apparatus 1 can include a water redistribution device (WRD). The WRD can be configured as an adsorber device that can adsorb moisture (e.g. water) from gas passed through at least one bed (Bed) of adsorbent material within a vessel of the WRD in some embodiments. The bed of adsorbent material can be sized and configured to adsorb water from the gas for redistribution of the water within gas passed through the WRD so that a product gas output from the WRD can be provided to a downstream end user within a pre-selected purification range (e.g. 99 vol % to 100 vol % pure nitrogen, 99 vol % to 100 vol % pure oxygen, 99 vol % to 100 vol % argon, a product gas having no more than 5 ppb water, a product gas having no more than 100 ppb water, etc.). For example, the bed of adsorbent material can include 13X adsorbent material, molecular sieve adsorbent material, or other suitable adsorbent material for adsorption of water from the product gas passed through the bed to dry the product gas and remove water from the product gas so that the product gas output from the WRD meets a pre-selected product gas purity content threshold (e.g. has between 5 ppb and 2 ppb water and is between 99.9 vol % and 100 vol % nitrogen, has between 100 ppb and 2 ppb water and is between 99.9 vol % and 100 vol % nitrogen, is at least 99.9 vol % oxygen and between 10 ppb and 2 ppb water, etc.).

The adsorbent material within the bed (BED) of the vessel of the WRD can be selected to help define an overall size of the WRD. In some embodiments, the adsorbent material can be selected so that the WRD has a designed size that is sufficiently small to facilitate economical manufacture and installation and/or use of the WRD while also using a sufficient amount and type of adsorbent material suitable for adsorption of the water that is anticipated as being able to occur when product gas passes through newly installed conduit elements that have been exposed to moisture. In some embodiments, the Henry adsorption constant, or Henry's adsorption isotherm, of the adsorbent material of the bed can be selected to help minimize the size of the vessel of the WRD and the bed of adsorbent material while providing sufficient water adsorption capacity for the anticipated water adsorption or water redistribution function to be provided for transport of a product gas via newly installed conduit elements that may have been exposed to external conditions or moisture (e.g. rain, dew, frost, humid conditions, etc.).

The water adsorption capacity of the adsorbent material utilized in the bed (BED) of the WRD can be in a desired range to provide a desired capacity of water adsorption. For example, in some embodiments, adsorbent material utilized in the bed (BED) of the WRD can have a range of between greater than 0.10 kg water adsorbed per 100 kg of adsorbent material and 0.40 kg water adsorbed per 100 kg of adsorbent material when operating at 30° C. in conjunction with a gas flow having a partial pressure of water of 0.0000005 psi and 0.000015 psi (which is between 0.0344 Pa and 0.1 Pa). For example, the adsorbent material can be selected to provide at least 0.10 kg water adsorbed per 100 kg of adsorbent material when exposed to a product gas at 30° C. with a partial pressure of water of 0.0344 Pa and can provide a water adsorption capacity of 0.40 kg water adsorbed per 100 kg of adsorbent material when exposed to a product gas at 30° C. with a partial pressure of water of 0.1 Pa. As another example, adsorbent material utilized in the bed (BED) of the WRD can have a range of between greater than or equal to 0.10 kg water adsorbed per 100 kg of adsorbent material and 0.80 kg water adsorbed per 100 kg of adsorbent material when operating at 30° C. in conjunction with a gas flow having a partial pressure of water of 0.0000005 psi and 0.000015 psi (which is between 0.0344 Pa and 0.1 Pa).

Other embodiments may utilize other adsorbent material having other types of adsorption profiles. There can be a tradeoff between high adsorption capacity and cost of adsorbent material as well as a tradeoff between vessel sizing for the WRD and cost of manufacture, shipping, installation, and/or use due to the vessel sizing of the WRD that can be accounted for in providing a WRD for a particular embodiment to meet a particular set of design objectives. In many situations, we believe that the adsorbent material of the bed having a water adsorption capacity of between 0.10 (kg water adsorbed per 100 kg of adsorbent material) and 0.40 (kg water adsorbed per 100 kg of adsorbent material) can provide sufficient water adsorption capacity for a particular operational environment while also permitting the sizing of the WRD to be provided in an economical manner that can permit economical fabrication, shipment, installation, and/or use.

The apparatus 1 can be configured to implement a process for production and/or delivery of a product gas of an ASU. As noted herein, the product gas can be nitrogen, argon, or oxygen, for example. It is also contemplated the product gas may be another product gas (e.g. xenon, neon, krypton, etc.).

For example, an ASU 3 can be provided that is configured to receive at least one feed gas (e.g. air, an industrial gas including flue gas, etc.) and perform separation of that feed gas to form at least one product stream. The air separation can utilize cooling of the feed gas and distillation of the feed gas using one or more distillation columns, for example. The product stream can include a product gas. For instance, the product stream can be a product gas that includes nitrogen, oxygen, or argon. The purity of the formed product gas can meet a pre-selected purity specification. For instance, the pre-selected purity specification can be a content of nitrogen that is at least 99 vol % nitrogen, or between 99.9 vol % nitrogen and 99.999999 vol % nitrogen. As another example, the pre-selected purity specification can be a content of oxygen that is at least 99 vol % oxygen, or between 99.9 vol % oxygen and 99.999999 vol % oxygen. As yet another example, the pre-selected purity specification can be a content of argon that is at least 99 vol % argon, or between 99.9 vol % argon and 99.999999 vol % argon. The pre-selected purity content of the product gas can also be defined in other ways or include other requirements. For example, the pre-selected purity content of the product gas can include a requirement that the product gas can have less than or equal to 5 parts per billion (ppb) water to 2 ppb water within the product gas. As another example, the pre-selected purity content of the product gas can include a requirement that the product gas has between 20 ppb and 2 ppb water within the product gas (e.g. less than or equal to 20 ppb water) or between 10 ppb and 2 ppb water.

The product stream can be output from the ASU 3 for feeding to a customer system 20 via product stream output conduit arrangement 11 that is positioned between the ASU 3 and the customer system 20. The customer system 20 can include industrial equipment configured to utilize the product gas output from the ASU 3 for at least one customer specific purpose via customer equipment at the customer site having the customer system 20.

The conduit arrangement 11 can include piping, valves V, and other equipment for transporting the product gas output from the ASU 3 to the customer system 20. For example, the conduit arrangement 11 can include an ASU product gas output conduit 11a connected between an output compressor 5 (Comp.) and the ASU 3. The output compressor 5 can be utilized to increase the pressure of the product gas to convey the gas to the customer system 20. In some embodiments, it is contemplated that the output compressor 5 may not be needed (e.g. because the ASU 3 outputs the product gas at a sufficiently high pressure so that there is no need for use of the compressor 5).

The conduit arrangement can also include a compressor output conduit 11b that is connected between the compressor 5 and a conduit split location 7. The conduit split location 7 (SL) can include a splitter conduit segment that is sized and configured to allow the product gas passed through the conduit arrangement 11 to be fed to the WRD to undergo treatment therein or to bypass the WRD so that the product gas does not pass through the WRD depending on the positions of different valves V of the conduit arrangement 11. The conduit split location (SL) can be positioned between the ASU 3 and the customer system 20 to permit bypassing or non-bypassing of the WRD depending on the water concentration and/or purity of the product gas that is detected as being feedable to the customer system 20.

The purity detection of the product gas can be provided via at least one sensor S connected to the conduit arrangement 11 for detecting the purity of the product gas. In some embodiments, the one or more sensors S can be configured as water content detection sensors, water content analyzers, or other type of sensor device configured for providing data that can be utilized to detect a water concentration within the product gas. For example, there can be a first sensor S1 positioned upstream of the conduit split location 7 and a second sensor S2 positioned downstream of the WRD and downstream of the split location 7 for detection of the water content within the product gas and/or the purity level of the product gas for determining whether the WRD can be bypassed or not. In other configurations or implementations, the sensors can be another type of product gas composition detection mechanism or product gas content analyzer.

In some embodiments, each of the sensors S and valves V can be communicatively connected to a controller (CTRL) that has a processor (CPU) connected to a non-transitory memory (MEM) and at least one transceiver (TCV). The controller (CTRL) can have communicative connections CC with the valves V, sensors S and controller (CTRL) so that the controller can determine whether the purity content of the product gas to be delivered to a customer system 20 meet one or more pre-defined purity content thresholds based on data received from the first and second sensors S1 and S2. The controller (CTRL) can communicate with the valves V to adjust the product gas flow for (1) feeding the product gas to the WRD for being treated therein or (2) bypassing the WRD.

One or more of these sensors S can also be utilized to determine if valves should be adjusted for venting of the product gas instead of conveying the gas to the customer system 20. For example, the controller (CTRL) can also be configured to utilize data from the second sensor S2 to determine whether or not venting of the product gas is needed based on a detected purity concentration of the product gas downstream of the WRD and the split location 7 that can be provided via the second sensor S2. If venting is needed, the controller (CTRL) can communicate with the valves V so that one or more vent valves V can be adjusted to their open positions while other valves V of the conduit arrangement 11 are moved to their closed positions to provide such venting. For example, if the product gas is detected as being unable to meet a pre-selected end customer purity requirement (e.g. water content of less than or equal to 10 ppb and greater than or equal to 2 ppb), the controller (CTRL) can communicate with the valves V for venting of the product gas until the purity of the product gas is detected as meeting or being within the pre-selected customer purity threshold. While such venting can be provided as a safety precaution, embodiments of the apparatus 1 can be configured to help minimize such venting or avoid the need for such venting.

The conduit arrangement 11 can include a WRD feeding conduit 11c that is positioned between the split location 7 and the WRD so product gas can be passed from the split location 7 to the WRD for undergoing treatment therein (e.g. being passed through at least one bed of adsorbent material of the WRD). The WRD feeding conduit 11c can include a WRD feed valve V1 that is adjustable between open and closed positions to facilitate bypassing of the WRD when the valve is in its closed position and feeding the product gas to the WRD for undergoing treatment therein when the valve is in its open position. The WRD feed valve V1 can be communicatively connectable to the controller (CTRL) such that the controller can actuate adjustment of this valve from its open position to its closed position and vice versa. As noted above, such adjustment can occur based on the controller's evaluation of sensor data received from the first and/or second sensors S1, S2.

The WRD can output treated product gas via a WRD output conduit 11d of the conduit arrangement 11 that is connected between the WRD and the customer system 20. In some configurations, the conduit arrangement 11 can include a filter 9 that is downstream of the WRD and between the WRD and the customer system 20. The filter 9 can be configured to help facilitate filtration of the product gas to help remove impurities from the product gas output from the WRD (e.g. particulate material, etc.). The conduit arrangement can include a filter output conduit 11e that is connected between the filter 9 and the customer system 20 when a filter 9 is utilized. The filter output conduit 11e can also be positioned between the customer system 20 and the WRD output conduit 11d in such an embodiment.

The conduit arrangement can also include a WRD venting conduit 11f that can be connected to the filter output conduit 11e (when used) or the WRD output conduit 11d. The WRD venting conduit 11f can include a WRD venting valve V2. The WRD venting valve can be adjustable between open and closed positions to facilitate venting of product gas output from the WRD and/or filter 9 when the valve is in its open position and feeding the product gas output from the WRD and/or filter to the customer system 20 when the WRD venting valve V2 is in its closed position.

The WRD venting valve V2 can be communicatively connected to the controller (CTRL) such that the controller can actuate opening or closing of the valve in some embodiments. As noted above, such adjustment can occur based on the controller's evaluation of sensor data received from the first and/or second sensors S1, S2.

A WRD output valve V3 can be included in the conduit arrangement 11. Such a valve can be downstream of the WRD venting valve V2 and can be connected to the filter output conduit 11e (when used) and/or the WRD output conduit 11d. The WRD output valve V3 can be adjustable between open and closed positions and be communicatively connected to the controller (CTRL) for actuation of the adjustment of the position of this valve between its open and closed positions.

For example, if venting via opening of the WRD venting valve is desired, the WRD output valve V3 can be moved to a closed position. Also, if the WRD is to be bypassed, this valve can be moved to its closed position. In situations where the product gas is to be treated via the WRD, the WRD output valve V3 can be moved to its open position so that the treated gas output from the WRD can be passed through the conduit arrangement 11 to the customer system 20. As noted above, the adjustment in position for the WRD output valve V3 can occur based on the controller's evaluation of sensor data received from the first and/or second sensors S1, S2 and the controller communicating with this valve V3 via a communicative connection CC between the controller and the WRD output valve V3.

The WRD output conduit 11d and/or the filter output conduit 11e (when used) can be connected to a customer delivery output conduit 110 at a treated product gas feed location 13 so that treated product gas output from the WRD is passable through the customer delivery conduit 110 when the WRD output valve V3 is in its open position so that the treated product gas can be passed to a customer inlet conduit 20a of the customer system 20. The customer system 20 can receive the product gas via the customer inlet conduit 20a for use at the customer system 20.

The conduit arrangement 11 can also include a WRD bypass conduit 11g that is positioned downstream of the split location 7 and connected to the split location 7 so that product gas passed through the WRD bypass conduit 11g is not passed through the WRD. The WRD bypass conduit 11g can include a number of valves positioned between the split location 7 and the treated product gas feed location 13 of the customer delivery conduit 110 so that product gas that is passed through the WRD bypass conduit 11g can be received by a customer inlet conduit 20a of the customer system 20 for receipt of the product gas for use at the customer system 20 without the product gas being treated by the WRD (e.g. by entirely bypassing the WRD).

For example, the WRD bypass conduit 11g can include bypass conduit valve V4 and a first venting conduit segment 11h that has a first venting valve V5. The WRD bypass conduit 11g can be connected to a customer delivery output conduit 110 that is positioned between the WRD bypass conduit 11g and the WRD output conduit 11d (as well as the filter output conduit 11e when a filter is utilized) as well. Product gas that is passed through the WRD bypass conduit 11g can be passed through the customer delivery output conduit 110 for being fed to the customer inlet conduit 20a for being provided to the customer system 20. Such product gas may never be passed through the WRD (and filter 9 when utilized) as the product gas is fed to the customer system 20.

The bypass conduit valve V4 can be positioned downstream of the split location 7 and be adjustable between an open position and a closed position. The bypass conduit valve V4 can be in a closed position when the product gas is to be passed to the WRD for treatment therein. The bypass conduit valve V4 can be moved to its open position when bypassing of the WRD is desired. The controller (CTRL) can be communicatively connected to the bypass conduit valve V4 to actuate adjustment of this valve between its open and closed positions based on the sensor data as noted above, for example.

The first venting valve V5 can also be adjustable between its open position and its closed position based on whether venting is determined to be warranted. For example, the first venting valve V5 can be in a closed position when the product gas is determined to have a sufficient purity level to meet a pre-selected purity threshold. The controller (CTRL) can communicate with the first venting valve to move this valve to its open position when venting is determined to be needed (e.g. due to the purity of the product gas being determined to be insufficient). When the first venting valve V5 is in its open position, product gas passing through the bypass conduit 11g can be vented instead of being conveyed to the customer system 20.

The customer delivery output conduit 110 can include a second venting conduit segment 11i that has a second venting valve V6. The second venting conduit segment 11i and second venting valve V6 can be positioned at a location that is upstream of the customer inlet conduit 20a and upstream of an outlet of the customer delivery output conduit 110 that can be connected to a customer delivery valve V7 of the customer delivery conduit 20a.

The customer delivery valve V7 of the customer delivery conduit 110 can be positioned between the customer system 20 and the customer delivery output conduit 110 to control whether the product gas is feedable to the customer system 20 (e.g. when the customer delivery valve V7 is in its open position) or prevented from being fed to the customer system 20 (e.g. when the customer delivery valve V7 is in its closed position). The customer delivery valve V7 can be downstream of the bypass conduit valve V4 and also be downstream of the treated product gas feed location 13.

In the event the second sensor S2 provides data indicating that the product gas is unable to meet a pre-selected purity threshold, the second venting valve V6 can be adjusted to its open position and the customer delivery valve V7 can be moved to its closed position so that such gas is vented instead of being provided to the customer system. In the event the product gas is detected as having a sufficient purity (e.g. at least meeting the pre-selected purity threshold via detection provided by the second sensor S2 positioned upstream of the customer delivery valve V7), the second venting valve V6 can be in its closed position and the customer delivery valve V7 can be in its open position so that the product gas is passable from the customer delivery conduit 110 of the conduit arrangement 11 to the customer system 20 via the customer inlet conduit 20a. The controller (CTRL) can be communicatively connected to these valves V for actuating adjustments in their positions based on the data provided by the second sensor S2 and/or first sensor S1.

The first sensor S1 can be utilized to determine whether the product gas output from the ASU may need to be passed through the WRD for treatment therein or not. For example, if data from the first sensor S1 indicates that the product gas may not have a sufficient purity level, the valves V can be adjusted between closed and opened positions so that the product gas is passed through the WRD feed conduit 11c for feeding to the WRD. However, if the first sensor S1 provides data indicating that the product gas has a sufficient purity level, the controller CTRL can utilize such data to determine that the WRD can be bypassed. Such a determination can also be based on the purity content data for the second sensor S2 and a duration of time at which the gas has been passed through the WRD for adsorption of any water from conduit segments of the conduit arrangement that may have been exposed to moisture during an installation phase of the conduit arrangement.

In the event the controller (CTRL) determines that the WRD can be bypassed, the WRD feed valve V1 and WRD output valve V3 can be closed and the bypass valve V4 can be opened so that the product gas is passed through the bypass conduit 11g instead of the WRD feeding conduit 11c.

In some embodiments, the controller (CTRL) can be provided such that the controller determinations are automated. In other embodiments, controller determinations can be made as a result of receipt of input from a user or operator that can provide manual or semi-automatic oversight or control. In some embodiments, the operator can utilize a computer device such as the controller (CTRL) or a computer device communicatively connectable to the controller (CTRL) to receive sensor data to evaluate that sensor data and provide input to the controller and/or valves for adjustment of different valve positions.

We have determined that utilization of the WRD and bypass feature provided by the bypass conduit 11g can permit initial start-up of the ASU 3 and/or initially providing of a product gas via a newly installed conduit arrangement 11 for conveying product gas to a customer system 20 to occur more quickly and avoid venting of product gas that may be produced during an initial start-up phase or initial delivery phase. For instance, newly installed pipe of the conduit arrangement often is exposed to water during the installation process (e.g. the piping or other conduit elements can be outside and installed underground or above ground and, during the construction phase, can be exposed to rain or other sources of water from the weather or outside environment). Conventionally, many weeks of passing product gas through such conduit elements can be needed to remove the water from the conduit elements so that the product gas conveyed through the conduit arrangement does not adsorb water and thereby reduce its purity content to an undesired level that may be out of a pre-selected content specification. This can be particularly true in high purity situations (e.g. where the product gas is to have a very high purity of over 99.99 vol % of a product composition such as nitrogen, oxygen, or argon). By utilization of the WRD, the product gas can be further dried via the adsorbent material of the bed of the WRD so that the water from the conduit elements that may be adsorbed by the product gas during an initial phase of conveyance or production is removed and the purity of the product gas is able to thereby meet the pre-selected purity specifications of a customer for use at a customer system 20. This can allow avoidance of venting (and lost product) as well as speed up the delivery time frame by numerous weeks.

Further, use of the bypass conduit 11g can permit the pressure drop associated with use of the WRD to be avoided once the conduit arrangement 11g has been sufficiently dried via the product gas being passed through the various piping while having adsorbed water removed via the WRD. Once such a condition is determined to have been met, the bypass conduit 11g can be used for conveyance of the product gas to the customer system 20 and the WRD can be bypassed so that it is no longer utilized. This bypassing can reduce the compressor duty or avoid the need of a compressor for continued providing of the product gas to the customer system 20.

Also, we have determined that providing a bypass conduit 11g arrangement can permit a single WRD to be provided for removable coupling to the conduit arrangement 11. Such a feature can permit a single WRD to be used at multiple different sites at different times to accommodate starting up of the supply of product gas from an ASU to a customer system 20 so that such a supply can occur more quickly at the different sites while also permitting the capital costs associated with the WRD to be more efficiently distributed over multiple uses at different sites.

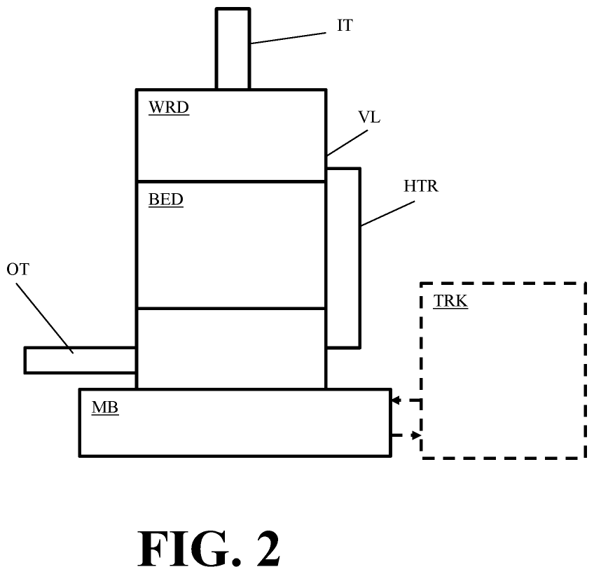

For example, as may best be seen in FIG. 2, some embodiments of the WRD can be configured so that the WRD is a vessel having a bed of adsorbent material therein that is supported on a mobile base (MB). The mobile base (MB) can be a truck trailer or skid, for example. A vehicle (TRK), such as a truck or other type of vehicle, can be connectable to the mobile base (MB) to tow or otherwise transport the mobile base (MB) that has the vessel of the WRD thereon to different locations as indicated by the broken line arrows.

The WRD can be decoupled via decoupling of the inlet (IT) and outlet (OT) of the WRD from the conduit arrangement 11 and subsequently transporting the WRD to a new location via movement of the mobile base (MB). The WRD can be coupled to a new conduit arrangement at a new site via coupling the WRD's inlet to a WRD feeding conduit 11c and coupling the WRD's outlet to a WRD outlet conduit 11d of a conduit arrangement 11 provided at the new site.

This type of coupling, use, decoupling, and movement of the WRD to a new location can be repeated numerous times to support new start-up of product gas delivery and/or initial startup of ASU operations for different ASU sites at various different geographically remote locations. The repeated usability of the WRD can permit a single WRD to support numerous different installations so that start-up operations for providing of product gas can occur much more quickly while also keeping the capital costs associated with such improved delivery times low. This type of operational functionality and mobility of the WRD can provide enhanced operational flexibility for ASU installations and ASU operations.

The WRD can be configured as an adsorber in some embodiments. For instance, the WRD can be configured as a vertical adsorber, horizontal adsorber, or a radial adsorber that has a bed of adsorbent material within the vessel of the adsorber. The bed of adsorbent material (BED) can be a bed of molecular sieve adsorbent material (e.g. 13X adsorbent material, etc.) in some embodiments. The bed of adsorbent material can be retained within a cavity of the vessel (VL) of the WRD.

The WRD can be configured to help re-distribute how water of the installed conduit arrangement 11 is removed from the conduit elements and included into the product gas to better meet customer purity specifications. In some embodiments, the WRD can be operated so that the bed of adsorbent material is sized to provide drying of the product gas. After the product gas is sufficiently dried, the adsorbent material can retain the adsorbed moisture. Over time, as the product gas no longer adsorbs moisture from the conduit elements due to the conduit elements drying as a consequence of having product gas passed through those elements and then having that water adsorbed via the bed of adsorbent material of the WRD, the conditions in the WRD vessel can change such that the adsorbent material no longer functions to adsorb water, but instead releases water to the drier product gas passed through the WRD, which thereby regenerates the adsorbent material of the bed of the WRD. This adsorption and subsequent desorbing of the water into the product gas passed through the WRD can be provided to accommodate customer purity specifications so that the product gas meets a pre-selected purity threshold while also permitting the adsorbent material of the bed of the WRD to be regenerated for repeated uses (e.g. for being subsequently bypassed, decoupled from the conduit arrangement, and moved to a new location as noted above after the adsorbent material has been regenerated, or for being available on site for a new use in response to a new purity detection issue that may arise as a result of maintenance work, a turndown, or other condition, etc.).

The WRD can also include a regeneration heater (HTR) attached to the vessel (VL) to provide heating (e.g. via at least one electric heating element of the regeneration heater) to the vessel to help heat the bed of adsorbent material during the regeneration phase of WRD treatment of the product gas. The regeneration heater (HTR) can be actuated to help facilitate desorption of the water from the adsorbent material after the conduit elements of the conduit arrangement are determined to have been dried via operation of the WRD and removal of the water from the product gas provided via the operation of the WRD. This type of determination can be made based on the duration of operation of the WRD, estimated amount of moisture that may have been needed to be removed from the installed conduit elements of the conduit arrangement 11, and/or sensor data from the first sensor S1 and/or second sensor S2.

The WRD's ability to transiently remove the water from the conduit elements of the conduit arrangement for redistribution of the water via subsequent desorption can be enhanced by use of the regeneration heater (HTR) in some embodiments. For example, the actuation of this heater (HTR) can facilitate the desorption of water from the bed of adsorbent material (BED) into the dry product gas in a manner that can still permit the product gas to meet the pre-selected purity threshold of a customer system 20. This functionality can permit the pipeline drydown process provided by the WRD to be a transient process because the adsorbent material of the WRD can be regenerated by desorption of the water into the product gas after the conduit elements have been dried via prior use of the WRD.

The use of the heater (HTR) may not be needed in some situations to facilitate adsorbent material regeneration. For example, in situations where the WRD inlet conditions change over time, the moisture level within gas being fed to the WRD will change over time and become lower and lower. Once the moisture level within the product gas at the inlet of the WRD reaches a certain dryness level, the water within the adsorbent material can be desorbed (e.g. passed from the adsorbent material to the dry product gas). The bed size and size capacity of the WRD can be selected such that this type of desorption of water can occur while still permitting the product gas output from the WRD to meet the pre-selected purity specification for the product gas. Whether the heater is to be actuated for facilitating such regeneration can be based on the equilibrium conditions associated with WRD treatment of the product gas.

For example, an expected operational moisture profile of the bed of adsorbent material of the WRD with increasing process time in treating product gas that we determined in evaluation of embodiments of our apparatus and process has surprisingly shown that the water content within the product gas can start at a high concentration during the initial treatment of the product gas and that it will subsequently equilibrate to a low level that is equivalent to the equilibrium water pressure with the water from the gaseous product upstream as the conduit elements of the conduit arrangement dry as a consequence of operation and passing of the product gas through conduit elements and the WRD over the course of days of operation.

At some point during WRD treatment processing, the water concentration in the product gas being passed out of the WRD can exceed the water concentration in the inlet product gas fed to the WRD. This property is unique to a sorbent based process with a decaying inlet water concentration that can be present as the conduit elements of the conduit arrangement 11 are dried during the course of operation (e.g. the water of those elements is adsorbed via the adsorbent material of the bed of the WRD).

Due to the nature of the time-dependent water inlet, the adsorbent material in the bed of the WRD can have two distinct periods with on-stream operation: a water adsorption period and a water desorption period where retained water will reach a maximum around the transition from the water adsorption period and subsequent water desorption period. For example, the inlet gas gradually becomes dryer over time as the conduit elements are dried during a first water adsorption period of use of the WRD, and when this maximum level of water saturation within the bed of adsorbent material is reached, the product gas passed through the WRD can start to function as a regeneration gas instead of a gas undergoing drying via water adsorption (e.g. the passing of the product gas through the WRD can transition from having water removed from the product gas to having water desorbed off the adsorbent material for adsorption into the product gas). At this second point in the operational profile of WRD use, the inlet product gas can start removing water from the adsorbent material, and the water that was previously captured by the WRD via adsorption will be released and entered the now much dryer product gas being fed into the WRD.

As noted above, a heater (HTR) can optionally be provided so that the heater (HTR) can optionally be actuated to help facilitate improved desorption of the water when this condition is reached in situations where increasing the temperature of the adsorbent material can help facilitate a desired rate of desorption of the water for regeneration of the adsorbent material. This regeneration of the adsorbent material does not require the water removed from the conduit elements and product gas via prior operation of the WRD to be removed from the apparatus (e.g. venting is not required) as the drier product gas may receive the water from the adsorbent material at a sufficiently low level to still meet customer purity specifications while also facilitating regeneration of the adsorbent material within the bed of the WRD.

After the water is removed from the adsorbent material via this water desorption period of the product gas being passed through the WRD, the adsorbent material can be ready to handle another significant transient water spike whether that is from a process upset, maintenance after a turndown, or removing the WRD from a first site to move it to a new site for use at a new location.

While full regeneration of the adsorbent material of the WRD can be provided, it is not necessary that the adsorbent material or WRD be removed after full regeneration. Instead, embodiments can be utilized in which the WRD and the adsorbent material of the WRD can be decoupled and removed (or just bypassed) at any time after the conduit elements have been sufficiently dried and the product gas passing through the conduit elements can meet the purity specification without needing to undergo treatment in the WRD. Also, the WRD does not have to remain on-stream until the adsorbent material itself is in equilibrium with the product gas. Moreover, for embodiments where the WRD may not be mobile, the WRD can also be left on site for an indefinite period of time (e.g. with the conduit arrangement being positioned for the product gas bypassing the WRD).

As discussed above, the WRD can be sized so that the bed of adsorbent material of the WRD has a capacity that is expected to adsorb the amount of water adsorbed or absorbed by new equipment that has been exposed to ambient humidity (e.g. outside conditions, rain, dew, frost, etc.) during installation work or maintenance work. The WRD sizing in some embodiments can be a function of the surface area of the conduit elements through which the product gas is to be passed and how much water that surface area is expected to add into product gas passed through the conduit elements. The type of adsorbent material and amount of adsorbent material utilized in the WRD can be determined based on a combination of the amount of water that's in excess of the equilibrium amount at the product gas purity specification and operating pressure (partial pressure of water) so that the amount of adsorbent material within the bed of the WRD is sufficient to adsorb and retain that water while in equilibrium with the product gas at an expected partial pressure of water.

The adsorption and subsequent desorption of water that can be provided by the WRD can permit water outgassing of installed conduit elements to occur in a way that can avoid significant delays in conveying of product gas through that installed conduit arrangement. Further, it can help facilitate the repeated use of the WRD at different locations as noted above without the need of having the adsorbent material of the WRD to be physically replaced due to the regeneration of that material that can be provided. This type of functionality can avoid waste (e.g. product gas lost to venting) and energy loss (e.g. loss of energy associated with production of product gas that is vented) by limiting venting or avoiding venting of the product gas formed by the operation of the ASU 3.

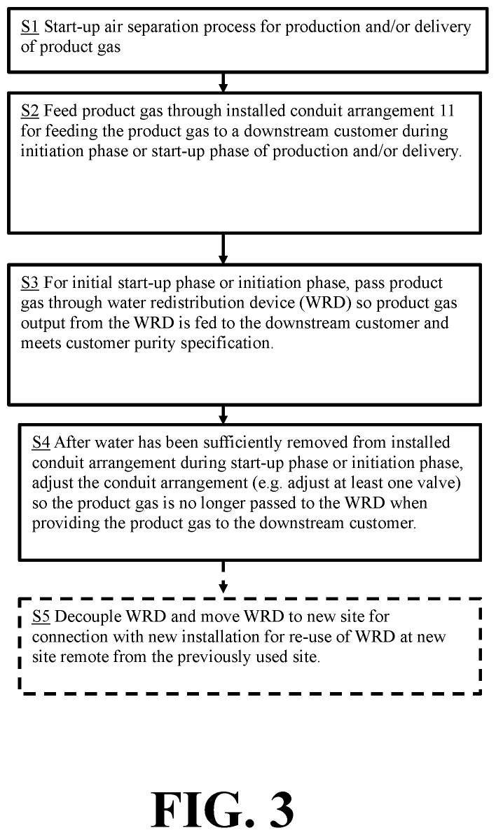

Embodiments of the apparatus 1 can be configured to implement an embodiment of our process for air separation product gas production and/or delivery. An exemplary embodiment of such a process is illustrated in FIG. 3. For instance, in a first step S1, an air separation process can be started up for production and/or delivery of a product gas. This start-up can be a start-up of a new ASU facility or the installation a conduit arrangement 11 for delivery of product gas to a customer system 20 for a pre-existing ASU facility.

In a second step S2, the product gas can be fed through the installed conduit arrangement 11 for feeding the product gas to a downstream customer (e.g. a downstream customer system 20 via a customer inlet conduit 20a as discussed above). This providing of the product gas in the second step S2 can occur during an initiation phase, or start-up phase of the production of the product gas and/or delivery of the product gas to a customer.

In a third step S3, the product gas can be passed through a WRD for treatment in the WRD during the initial phase, or start-up phase of the production and/or delivery of the product gas. The product gas can be passed through the WRD so the product gas output from the WRD is fed to the downstream customer (e.g. customer system 20) and meets a pre-selected product gas purity specification (e.g. a customer product gas purity specification).

The third step S3 of the process can also optionally include passing the product gas through the WRD to regenerate the adsorbent material of the WRD as discussed above. This adsorbent material regeneration can occur in combination with activation of a heater device (e.g. heater (HTR)). The regeneration of the adsorbent material can occur after the product gas has sufficiently dried the conduit elements of the conduit arrangement, for example.

In a fourth step S4, after water has been sufficiently removed from the conduit elements of the conduit arrangement 11 during the start-up phase, or initiation phase, of the production and/or delivery of the product gas, the conduit arrangement 11 can be adjusted so that the product gas is no longer passed through the WRD. For example, the bypass conduit 11g can be utilized so that product gas bypasses the WRD and is no longer passed to the WRD when being fed to the customer system 20 as discussed above.

In a fifth step S5 (shown in broken line in FIG. 3 as an optional step), the WRD can be decoupled from the conduit arrangement 11 and subsequently moved to a new site for connection to a new conduit arrangement at the new site. This type of removability and mobility of the WRD can permit the WRD to be used at different remote sites at different times as discussed above.

As discussed above, other embodiments can be utilized in which the WRD is left at its original site. The WRD can then be bypassed via the bypass conduit 11g while also still being available for treating product gas at other times in which it may be needed (e.g. a process upset, maintenance after a turndown, etc.).

Embodiments of the process can provide the above discussed advantages and benefits. For example, embodiments of the process can permit product gas to be delivered to a customer site more quickly, help avoid venting of product gas or minimize such venting, and provide improved operational flexibility.

It should be appreciated that other modifications can also be made to meet a particular set of criteria for different embodiments of the apparatus 1 or process. For instance, the arrangement of valves, piping, and other conduit elements (e.g., conduit connection mechanisms, tubing, seals, valves, etc.) for interconnecting different units of the apparatus for fluid communication of the flows of fluid between different elements (e.g., pumps, compressors, fans, valves, conduits, etc.) can be arranged to meet a particular plant layout design that accounts for available area of the apparatus, sized equipment of the apparatus, and other design considerations. For instance, the size of the vessel of the WRD, the type of WRD configuration (e.g. vertical adsorber, horizontal adsorber, radial adsorber, etc.), the size and configuration of valves, conduits and/or other elements can be modified to meet a particular set of design criteria. As another example, the flow rate, pressure, and temperature of the fluid passed through one or more elements of the apparatus 1 can vary to account for different plant design configurations and other design criteria. As yet another example, the processing units and how they are arranged can be adjusted to meet a particular set of design criteria. As yet another example, the material composition for the different structural components of the units of the apparatus can be any type of suitable materials as may be needed to meet a particular set of design criteria.

As yet another example, embodiments of the apparatus 1 and process can each be configured to include other process control elements positioned and configured to monitor and control operations (e.g., temperature and pressure sensors, flow sensors, an automated process control system having at least one work station that includes a processor, non-transitory memory and at least one transceiver for communications with the sensor elements, valves, and controllers for providing a user interface for an automated process control system that may be run at the work station and/or another computer device of the plant, etc.). It should be appreciated that embodiments can utilize a distributed control system (DCS) for implementation of one or more processes and/or controlling operations of an apparatus or process as well.

As another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of the process, apparatus, system, and methods of making and using the same have been shown and described above, it is to be distinctly understood that the invention is not limited thereto but may be otherwise variously embodied and practiced within the scope of the following claims.

What is claimed is:

1. An apparatus for production and/or delivery of a product gas of an air separation unit (ASU), the apparatus comprising:
a water redistribution device (WRD) configured to receive a product gas output from the ASU to remove water from the product gas to adjust a purity of the product gas so the product gas has a purity within a pre-selected purification content specification, the WRD being positionable between the ASU and a customer system to receive the product gas from the ASU and output the product gas at the purity within the pre-selected purification content specification to feed the product gas to the customer system.

2. The apparatus of claim 1, comprising the ASU and/or the customer system.

3. The apparatus of claim 1, comprising:
a conduit arrangement having a WRD feed conduit through which the product gas is passable to feed to the WRD and a WRD bypass conduit through which the product gas is passable to bypass the WRD and avoid being passed through the WRD when the product gas is fed to the customer system via the conduit arrangement.

4. The apparatus of claim 3, wherein the conduit arrangement includes a split location upstream of the WRD and the WRD bypass conduit, a WRD feed valve of the WRD feed conduit being adjustable between an open position for passing of the product gas to the WRD and a closed position for passing the product gas to the WRD bypass conduit.

5. The apparatus of claim 3, wherein the conduit arrangement includes a split location upstream of the WRD and the WRD bypass conduit, a WRD bypass valve of the WRD bypass conduit being adjustable between a closed position for passing of the product gas to the WRD and an open position for passing the product gas through the WRD bypass conduit.

6. The apparatus of claim 5, comprising a WRD feed valve of the WRD feed conduit that is adjustable between an open position for passing of the product gas to the WRD and a closed position for passing the product gas to the WRD bypass conduit

7. The apparatus of claim 1, wherein the WRD comprises a vessel retaining a bed of adsorbent material, the adsorbent material comprising a molecular sieve adsorbent material.

8. The apparatus of claim 3, wherein the WRD comprises a vessel retaining a bed of adsorbent material and the WRD is also configured to receive the product gas through the WRD after the conduit arrangement has been dried so that water adsorbed by the bed of adsorbent material desorbs into the product gas during a desorption phase of operation of the WRD such that desorbed water within the product gas still results in the product gas output from the WRD having the purity within the pre-selected purification content specification.

9. The apparatus of claim 7, comprising:
a regeneration heater connected to the vessel to heat the vessel for regeneration of the adsorbent material as the product gas is passed through the WRD.

10. The apparatus of claim 7, wherein the WRD is supported by a mobile base, the mobile base being connectable to a vehicle for transportation of the WRD.

11. The apparatus of claim 7, wherein the WRD has an inlet connected to the vessel and an outlet connected to the vessel, the inlet being removably connectable to the conduit arrangement and the outlet being removably connectable to the conduit arrangement.

12. The apparatus of claim 1, wherein the product gas is nitrogen and the pre-selected purification content specification is a water content of no more than 100 parts per billion (ppb) water and/or a nitrogen content of at least 99.9 volume percent nitrogen.

13. A process for production and/or delivery of a product gas of an air separation unit (ASU), the process comprising:
passing product gas output from the ASU to a water redistribution device (WRD) to adjust a purity of the product gas so the product gas has a purity within a pre-selected purification content specification, the WRD being connectable to a conduit arrangement positioned between the ASU and a customer system to receive the product gas from the ASU and output the product gas at the purity within the pre-selected purification content specification to feed the product gas to the customer system;
after water has been sufficiently removed from the conduit arrangement via the passing of the product gas to the WRD, adjusting the passing of the product gas so that the product gas bypasses the WRD as the product gas is passed from the ASU to the customer system.

14. The process of claim 13, comprising:
after the adjusting of the passing of the product gas so that the product gas bypasses the WRD, decoupling the WRD from the conduit arrangement and moving the WRD to another site for connection with a conduit arrangement of that site.

15. The process of claim 13, comprising:
activating a regeneration heater connected to a vessel of the WRD for heating the vessel for regeneration of adsorbent material of the WRD after determining that water has been sufficiently removed from the conduit arrangement via the passing of the product gas to the WRD and that desorption of the water into the product gas passed through the WRD will result in the product gas output from the WRD having the purity within the pre-selected purification content specification.

16. The process of claim 13, wherein the WRD comprises a vessel having a bed of adsorbent material therein; and wherein the passing of the product gas output from the ASU to the WRD to adjust a purity of the product gas so the product gas has the purity within the pre-selected purification content specification comprises:
passing the product gas through the WRD after the product gas has passed through the conduit arrangement such that the bed of adsorbent material adsorbs water from the product gas during a first adsorption phase of operation of the WRD; and
passing the product gas through the WRD after the conduit arrangement has been dried so that water adsorbed by the bed of adsorbent material desorbs into the product gas during a second desorption phase of operation of the WRD such that the desorbed water within the product gas still results in the product gas output from the WRD having the purity within the pre-selected purification content specification.

17. The process of claim 13, wherein the product gas is nitrogen and the pre-selected purification content specification is a water content of no more than 100 parts per billion (ppb) water and/or a nitrogen content of at least 99.9 volume percent nitrogen.

18. The process of claim 13, wherein the product gas is nitrogen, oxygen, or argon.

19. The process of claim 13, comprising:
starting up the ASU for producing the product gas to feed to the customer system.

20. The process of claim 13, comprising:
determining that the water has been sufficiently removed from the conduit arrangement via the passing of the product gas to the WRD such that the product gas is passable to the customer system without treatment via the WRD based on sensor data from sensors of the conduit arrangement, a surface area of the conduit arrangement, and/or a duration of time in which the product gas has been passed through the WRD.
